(19) United States
(12) Patent Application Publication
(10) Pub. No.: US 2026/0260971 A1
(43) Pub. Date: Sep. 3, 2026

(54) POWER STORAGE CELL AND METHOD FOR MANUFACTURING POWER STORAGE CELL

(71) Applicants: TOYOTA JIDOSHA KABUSHIKI KAISHA, Toyota-shi (JP); Prime Planet Energy & Solutions, Inc., Tokyo (JP)

(72) Inventors: Masato ONO, Nagoya-shi (JP); Norihiro OSE, Nagoya-shi (JP); Yasuhiro SAKASHITA, Nisshin-shi (JP); Koichi YANASE, Nagoya-shi (JP); Takeru HARA, Toyota-shi (JP); Yuka YOKOI, Nagoya-shi (JP); Kohji UMEMURA, Okazaki-shi (JP); Toshiki IMABORI, Kasai-shi (JP); Yoshinori HIRANO, Nagoya-shi (JP); Satoshi FUJIMURA, Toki-shi (JP)

(73) Assignees: TOYOTA JIDOSHA KABUSHIKI KAISHA, Toyota-shi (JP); Prime Planet Energy & Solutions, Inc., Tokyo (JP)

(21) Appl. No.: 19/459,114

(22) Filed: Jan. 26, 2026

(30) Foreign Application Priority Data
Feb. 28, 2025 (JP) 2025-031956

(51) Int. Cl. H01M 50/103; H01M 10/04; H01M 50/14; H01M 50/342; H01M 50/548; H01M 50/55

(52) U.S. Cl. CPC H01M 50/103; H01M 10/0481; H01M 10/049; H01M 50/14; H01M 50/3425; H01M 50/548; H01M 50/55; H01M 2220/20

(57) ABSTRACT

A power storage cell includes an electrode assembly and a housing case that houses the electrode assembly. The housing case includes a first side wall, a second side wall arranged away from the first side wall in an arrangement direction, and a body connecting the first side wall and the second side wall. The body includes a first end wall and a second end wall arranged away from the first end wall across the electrode assembly. The first end wall includes an exhaust valve and a protrusion that protrudes toward the electrode assembly.

### CROSS-REFERENCE TO RELATED APPLICATION

This application claims priority to Japanese Patent Application No. 2025-031956 filed on February 28, 2025. The disclosure of the above-identified application, including the specification, drawings, and claims, is incorporated by reference herein in its entirety.

### BACKGROUND

### Technical Field

The present disclosure relates to a power storage cell and a method for manufacturing the power storage cell.

### Description of Related Art

Various power storage cells have been proposed for use in power storage devices mounted on vehicles. For example, Japanese Unexamined Patent Application Publication No. 2000-067821 (JP 2000-067821 A) discloses a power storage cell including a housing case and an electrode assembly housed in the housing case. The housing case includes a first end wall, a second end wall, and a peripheral wall connecting the first end wall and the second end wall. The peripheral wall includes a first side surface and a second side surface that faces the first side surface across the electrode assembly. The first end wall includes an exhaust valve. The first side surface and the second side surface have recesses. The recesses can suppress movement of the electrode assembly within the housing case and suppress damage to the electrode assembly.

### SUMMARY

The power storage cell disclosed in JP 2000-067821 A has the recesses formed on the first side surface and the second side surface. This creates a space between the first side surface and the electrode assembly, and a space between the second side surface and the electrode assembly. The spaces created by the recesses cause a decrease in energy density of the power storage cell. It is preferable that a clearance be present between the exhaust valve formed on the first end wall and the electrode assembly. This is to ensure an exhaust path for gas generated within the housing case. Ensuring the exhaust path between the exhaust valve and the electrode assembly may accelerate the decrease in energy density of the power storage cell.

The present disclosure has been made in view of the above issues, and has an object to provide a power storage cell that can suppress movement of an electrode assembly within a housing case and suppress a decrease in energy density due to measures against movement of the electrode assembly, and provide a method for manufacturing the power storage cell.

A power storage cell according to the present disclosure includes an electrode assembly and a housing case that houses the electrode assembly. The housing case includes a first side wall, a second side wall arranged away from the first side wall in an arrangement direction, and a body connecting the first side wall and the second side wall. The body includes a first end wall and a second end wall arranged away from the first end wall across the electrode assembly. The first end wall includes an exhaust valve and a protrusion that protrudes toward the electrode assembly.

In the power storage cell according to the present disclosure, the protrusion may be provided by a recessed shape of the first end wall.

The power storage cell according to the present disclosure may further include an external terminal. The external terminal may be provided on at least one of the first side wall or the second side wall.

The power storage cell according to the present disclosure may further include an external terminal. The external terminal may be provided on the first end wall.

A power storage cell according to a method for manufacturing the power storage cell according to the present disclosure includes an electrode assembly, a housing case that houses the electrode assembly, and external terminals. The housing case includes a first side wall, a second side wall arranged away from the first side wall in an arrangement direction, and a body connecting the first side wall and the second side wall. The body includes a first end wall and a second end wall arranged away from the first end wall across the electrode assembly. The first end wall includes an exhaust valve and a protrusion that protrudes toward the electrode assembly. The external terminals include a first terminal provided on the first side wall and a second terminal provided on the second side wall. The electrode assembly, the external terminals, the first side wall, and the second side wall constitute an electrode assembly unit. The method includes: preparing the electrode assembly unit; inserting the electrode assembly unit into the body; joining the first side wall and the second side wall of the electrode assembly unit to the body; and pressing the first end wall to form the protrusion.

With the power storage cell according to the present disclosure, it is possible to suppress movement of the electrode assembly within the housing case and suppress the decrease in energy density due to the measures against movement of the electrode assembly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle including a power storage device according to an embodiment of the present disclosure;

FIG. 2 is a schematic diagram of the power storage device including a power storage cell according to the embodiment of the present disclosure;

FIG. 3 is an exploded perspective view of the power storage device according to the embodiment of the present disclosure;

FIG. 4 is a perspective view of the power storage cell according to the embodiment of the present disclosure;

FIG. 5 is a sectional view of the power storage cell shown in FIG. 4 as viewed in a direction of arrows V-V;

FIG. 6 is a modification of the power storage cell according to the embodiment of the present disclosure; and

FIG. 7 is a flowchart showing a method for manufacturing the power storage cell according to the embodiment of the present disclosure.

### DETAILED DESCRIPTION OF EMBODIMENTS

Hereinafter, an embodiment and a modification of the present disclosure will be described in detail with reference to the drawings. In the drawings, the same or corresponding parts are denoted by the same reference symbols and their descriptions will not be repeated.

### Embodiment

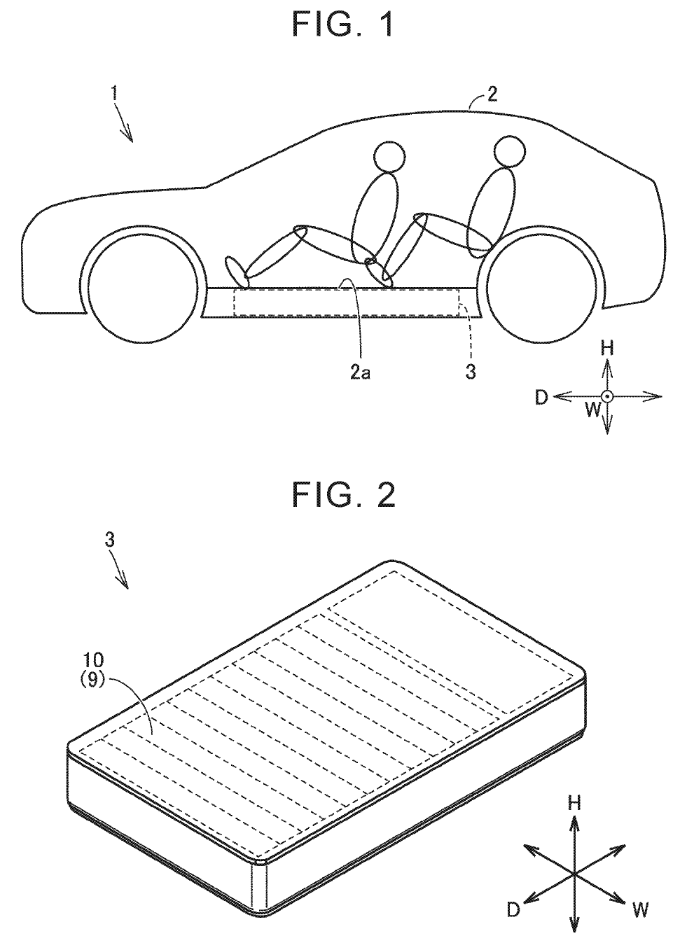

FIG. 1 is a schematic diagram of a vehicle including a power storage device according to the embodiment of the present disclosure. FIG. 2 is a schematic diagram of the power storage device including a power storage cell according to the embodiment of the present disclosure. An up-down direction H shown in FIG. 1 indicates an up-down direction of a vehicle 1. A width direction W indicates a width direction of the vehicle 1. A front-rear direction D indicates a front-rear direction of the vehicle 1. The width direction W is an example of an "arrangement direction" in the present disclosure.

The vehicle 1 includes a vehicle body 2 and a power storage device 3. Examples of the vehicle 1 include a plug-in hybrid electric vehicle (PHEV), a battery electric vehicle (BEV), and a fuel cell electric vehicle (FCEV). The power storage device 3 is disposed below a bottom 2a of the vehicle body 2.

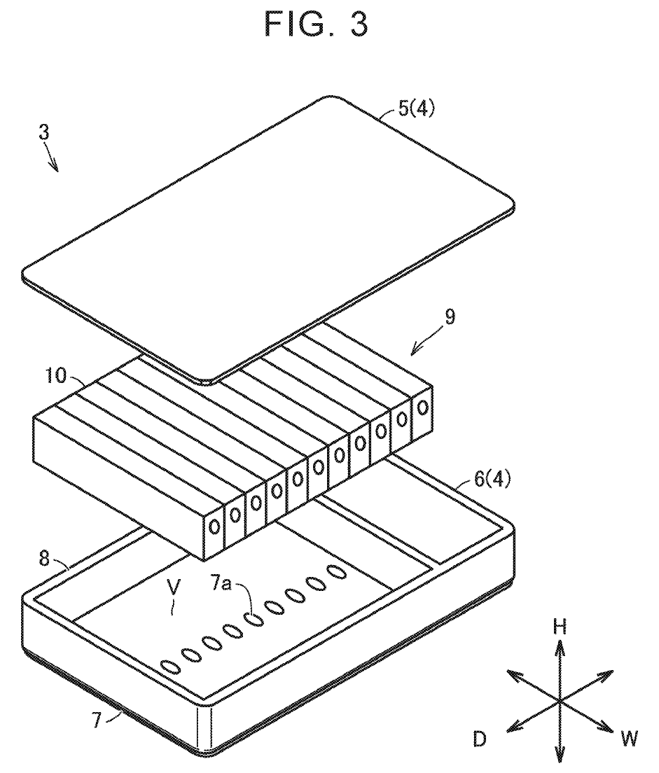

FIG. 3 is an exploded perspective view of the power storage device according to the present embodiment. The power storage device 3 includes a storage case 4 and a power storage stack 9.

The storage case 4 includes an upper cover 5 and a lower case 6. The storage case 4 has a housing space V defined by the upper cover 5 and the lower case 6.

The upper cover 5 covers the lower case 6 that is open upward.

The lower case 6 includes a bottom wall 7 and an upright wall 8. The bottom wall 7 supports the power storage stack 9 in the up-down direction H. The bottom wall 7 has openings 7a. The opening 7a is located to face an exhaust valve 24a described later. The upright wall 8 rises upward from the bottom wall 7 in the up-down direction H.

The power storage stack 9 is housed in the housing space V and is disposed on the upper surface of the bottom wall 7. The power storage stack 9 is formed from a plurality of power storage cells 10. The power storage cells 10 are arranged in the front-rear direction D. The power storage cell 10 has a rectangular parallelepiped shape that is elongated in the width direction W.

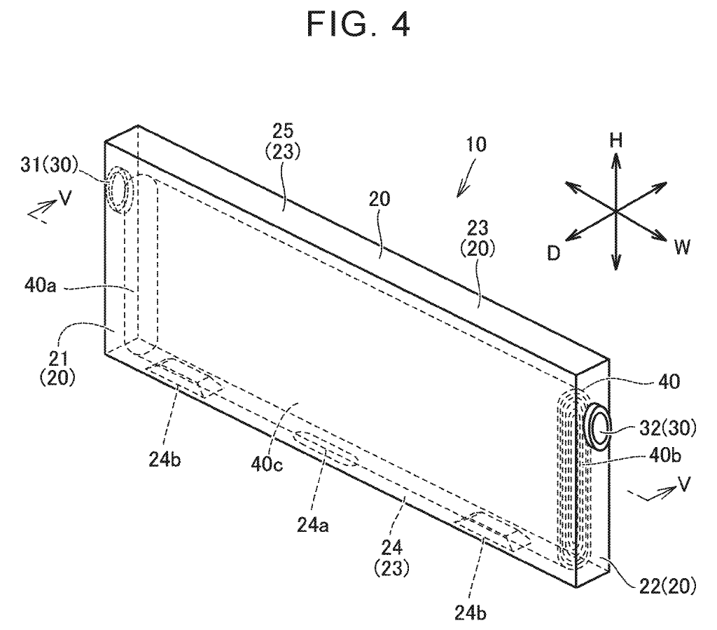

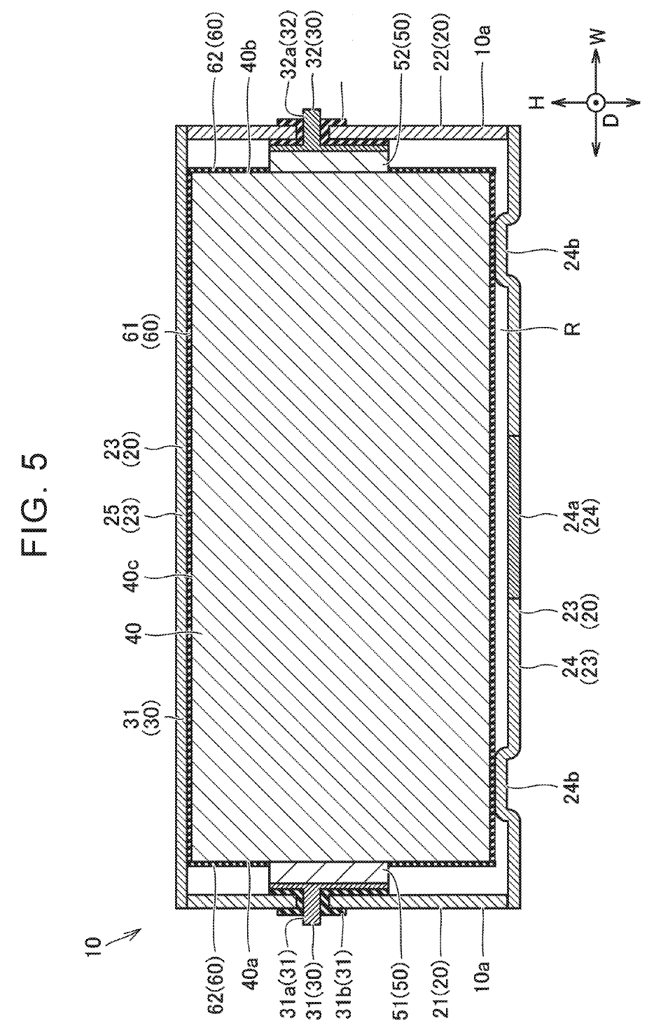

FIG. 4 is a perspective view of the power storage cell according to the embodiment of the present disclosure. The power storage cell 10 is a so-called prismatic battery extending in the width direction W. The power storage cell 10 may be a chargeable and dischargeable secondary battery such as a lithium ion battery or a nickel-metal hydride battery. The power storage cell 10 includes a housing case 20, external terminals 30, and an electrode assembly 40.

The housing case 20 is electrically conductive. The housing case 20 is made of a metal such as aluminum. The housing case 20 houses the electrode assembly 40. The housing case 20 also houses an electrolyte solution that is not shown in FIG. 4. The housing case 20 includes a first side wall 21, a second side wall 22, and a body 23. The first side wall 21 and the second side wall 22 are arranged away from each other in the width direction W. The body 23 connects the first side wall 21 and the second side wall 22. The body 23 has a tubular shape. When the body 23 is viewed at a distance in the width direction W, the body 23 has a substantially rectangular outer shape. The first side wall 21 is joined to the edge of the body 23. The second side wall 22 is joined to the outer peripheral edge of the body 23.

The body 23 includes a first end wall 24 and a second end wall 25. The first end wall 24 and the second end wall 25 are arranged away from each other in the up-down direction H across the electrode assembly 40. In the embodiment of the present disclosure, the first end wall 24 is located below the second end wall 25.

FIG. 5 is a sectional view of the power storage cell shown in FIG. 4 as viewed in a direction of arrows V-V.

The first end wall 24 includes the exhaust valve 24a and protrusions 24b.

The exhaust valve 24a is located at the center of the first end wall in the width direction W. The exhaust valve 24a is a known exhaust valve. For example, Japanese Unexamined Patent Application Publication No. 2013-243075 (JP 2013-243075 A) discloses the exhaust valve 24a including a general portion that is processed to be thinner than the first end wall 24. A rupture groove is formed in the general portion of the exhaust valve 24a. By appropriately designing this groove, a small increase in pressure inside the housing case 20 can selectively rupture the exhaust valve 24a. The groove is formed, for example, by a die and a punch. In a plan view of the groove in the up-down direction H, the groove has an elliptical or linear shape.

The protrusion 24b protrudes toward the electrode assembly 40. The protrusion 24b is formed by forming the first end wall 24 that is a plate-shaped member into a shape that is recessed toward the electrode assembly 40. In the embodiment of the present disclosure, two protrusions 24b are formed on the first end wall 24 away from each other in the width direction W across the exhaust valve 24a. By forming the protrusions 24b on the first end wall 24, a space R is formed between the first end wall 24 and the electrode assembly 40.

The external terminals 30 include a first terminal 31 and a second terminal 32. The first terminal 31 and the second terminal 32 are each electrically connected to the electrode assembly 40. In the embodiment of the present disclosure, the first terminal 31 is a cathode terminal and the second terminal 32 is an anode terminal.

The first terminal 31 is provided on the first side wall 21. The first terminal 31 includes a first conductive portion 31a and a first protective portion 31b. Part of the first conductive portion 31a is located inside the housing case 20 and is in contact with a first tab 51 described later. Part of the first conductive portion 31a is exposed from the housing case 20. The first protective portion 31b is electrically insulative. The first protective portion 31b is located between the first conductive portion 31a and the first side wall 21.

Similarly, the second terminal 32 is provided on the second side wall 22. The second terminal 32 includes a second conductive portion 32a and a second protective portion 32b. Part of the second conductive portion 32a is located inside the housing case 20 and is in contact with a second tab 52 described later. Part of the second conductive portion 32a is exposed from the housing case 20. The second protective portion 32b is electrically insulative. The second protective portion 32b is located between the second conductive portion 32a and the second side wall 22.

The electrode assembly 40 is, for example, a wound electrode assembly. The wound electrode assembly is formed by winding a sheet group in which a cathode sheet, a separator, and an anode sheet are laminated.

The electrode assembly 40 includes a first end surface 40a, a second end surface 40b, and a peripheral surface 40c. The first end surface 40a and the second end surface 40b are arranged away from each other in the width direction W. The first end surface 40a faces the first side wall 21. The second end surface 40b faces the second side wall 22. The peripheral surface 40c connects the first end surface 40a and the second end surface 40b.

The electrode assembly 40 further includes current collecting tabs 50. The current collecting tabs 50 include the first tab 51 and the second tab 52. The first tab 51 protrudes from the first end surface 40a in the width direction W toward the first side wall 21. The second tab 52 protrudes from the second end surface 40b in the width direction W toward the second side wall 22. The first tab 51 is electrically connected to the cathode sheet (not shown) of the electrode assembly 40. The second tab 52 is electrically connected to the anode sheet (not shown) of the electrode assembly 40. The first tab 51 is electrically connected to the first conductive portion 31a. The second tab 52 is electrically connected to the second conductive portion 32a.

The power storage cell 10 further includes an insulating film 60. The insulating film 60 is electrically insulative. The insulating film 60 is made of a film-shaped material. The insulating film 60 is disposed between the electrode assembly 40 and the housing case 20. The insulating film 60 provides electrical insulation between the housing case 20 and the electrode assembly 40. The insulating film 60 includes a peripheral surface insulating portion 61 and end surface insulating portions 62.

The peripheral surface insulating portion 61 is disposed between the electrode assembly 40 and the body 23. The end surface insulating portions 62 are disposed between the electrode assembly 40 and the first side wall 21 and between the electrode assembly 40 and the second side wall 22. The end surface insulating portion 62 has an opening through which the current collecting tab 50 passes.

The power storage cell 10 according to the embodiment of the present disclosure includes the housing case 20 and the electrode assembly 40 housed in the housing case 20. The housing case 20 includes the first end wall 24. The first end wall 24 includes the exhaust valve 24a and the protrusions 24b. The protrusion 24b protrudes toward the electrode assembly 40. By forming the protrusions 24b, the space R is formed between the first end wall 24 and the electrode assembly 40.

The protrusions 24b of the power storage cell 10 having such a configuration can suppress movement of the electrode assembly 40 within the housing case 20. It is preferable that a space be formed between the exhaust valve 24a formed in the housing case 20 and the electrode assembly 40 to ensure an exhaust path for gas generated within the housing case 20. In the power storage cell 10 of the present disclosure, the exhaust valve 24a and the protrusions 24b are formed on the first end wall 24. Therefore, the space R created by the protrusions 24b formed as measures against movement of the electrode assembly 40 also serves to ensure the exhaust path. That is, in the case where the exhaust valve 24a and the protrusions 24b are formed on the same wall (for example, the first end wall 24), a decrease in energy density of the power storage cell can be suppressed compared to the case where the exhaust valve 24a and the protrusions 24b are formed on different walls.

In the embodiment of the present disclosure, the protrusion 24b is formed by forming the first end wall 24 into a shape that is recessed toward the electrode assembly 40. By holding the electrode assembly 40 with the housing case 20 without adding any new members to the power storage cell 10, it is possible to suppress the decrease in energy density per unit mass of the power storage cell 10.

The protrusion 24b need not be formed by forming the first end wall 24 into the recessed shape. For example, a cushioning member may be disposed between the first end wall 24 and the electrode assembly 40. The cushioning member may be, for example, an elastic body, and may fill the space between the first end wall 24 and the electrode assembly 40.

In the embodiment of the present disclosure, the first end wall 24 including the exhaust valve 24a is located below the second end wall 25 in the up-down direction H. Thus, it is possible to suppress entry of gas discharged from the exhaust valve 24a into a vehicle cabin of the vehicle 1.

The embodiment of the present disclosure illustrates the example in which the external terminals 30 are provided on the first side wall 21 and the second side wall 22. However, the present disclosure is not limited to this.

For example, the external terminals 30 may be provided on at least one of the first side wall 21 or the second side wall 22. More specifically, the first tab 51 and the second tab 52 may be provided on the first end surface 40a of the electrode assembly 40. The first terminal 31 provided on the first side wall 21 and the first tab 51 are electrically connected to each other. Similarly, the second terminal 32 provided on the second side wall 22 and the second tab 52 are electrically connected to each other. Thus, it is possible to reduce the space between the second side wall 22 and the second end surface 40b of the electrode assembly 40, and to suppress the decrease in energy density of the power storage cell 10.

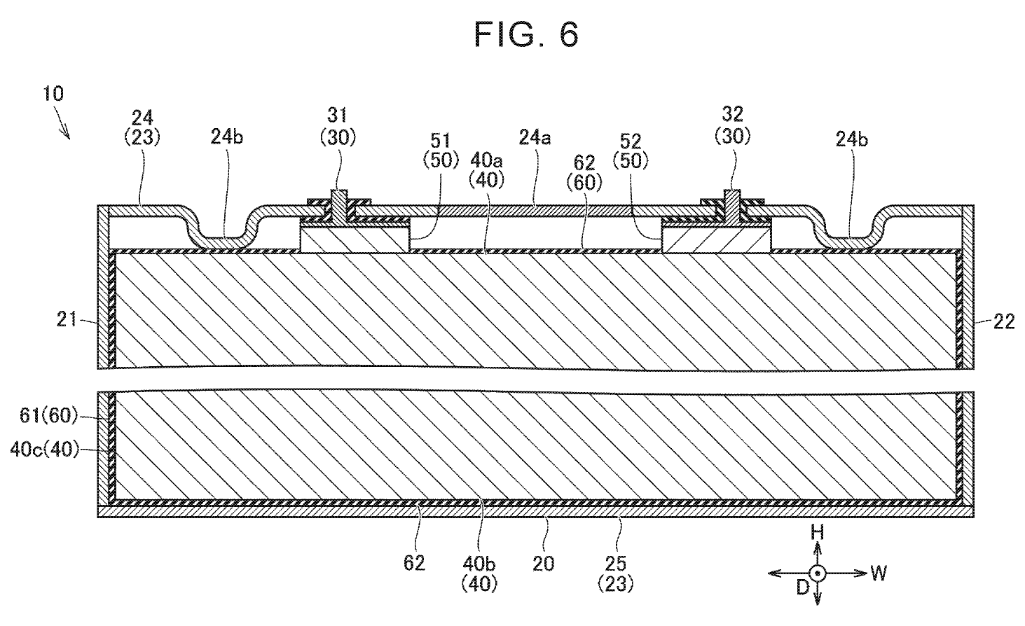

For example, as shown in FIG. 6, the external terminals 30 may be provided on the first end wall 24. More specifically, the first end surface 40a of the electrode assembly 40 may face the first end wall 24. The first tab 51 and the second tab 52 may be provided on the first end surface 40a. The first terminal 31 and the second terminal 32 of the external terminals 30 may be provided on the first end wall 24. The first terminal 31 and the first tab 51 are electrically connected to each other. The second terminal 32 and the second tab 52 are electrically connected to each other. Therefore, the current collecting tabs 50 are disposed in the space R created by the formation of the protrusions 24b. That is, it is possible to suppress the formation of a space for disposition of the current collecting tabs 50, and to suppress the decrease in energy density of the power storage cell 10. The first end wall 24 may be located either above or below the second end wall 25 in the up-down direction H.

### Method for Manufacturing Power Storage Cell

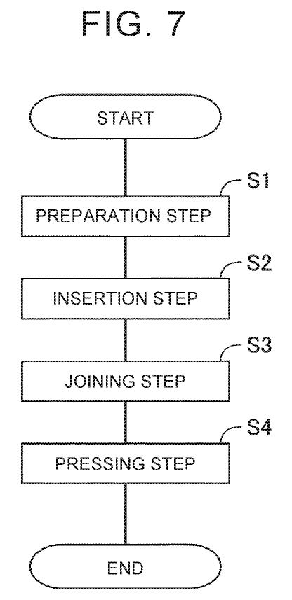

Next, an example of the method for manufacturing the power storage cell 10 will be described with reference to FIG. 7. FIG. 7 is a flowchart showing the method for manufacturing the power storage cell 10. As shown in FIG. 7, the method for manufacturing the power storage cell 10 includes, in order of steps, a preparation step S1, an insertion step S2, a joining step S3, and a pressing step S4. The steps will be described in detail below.

The preparation step S1 will be described. In the preparation step S1, an electrode assembly unit 10a and the body 23 are prepared. The electrode assembly unit 10a shown in FIG. 5 is formed by the first side wall 21, the second side wall 22, the external terminals 30, and the electrode assembly 40 surrounded by the insulating film 60. The external terminals 30 include the first terminal 31 and the second terminal 32. The first terminal 31 is provided on the first side wall 21. The second terminal 32 is provided on the second side wall 22. At the first end surface 40a, the first terminal 31 and the electrode assembly 40 are electrically connected to each other. At the second end surface 40b, the second terminal 32 and the electrode assembly 40 are electrically connected to each other.

Referring again to FIG. 7, in the insertion step S2, the electrode assembly unit 10a is inserted into the body 23.

In the joining step S3, the first side wall 21 and the second side wall 22 of the electrode assembly unit 10a are joined to the body 23.

In the pressing step S4, part of the first end wall 24 of the body 23 is pressed toward the electrode assembly 40 to form the protrusions 24b on the first end wall 24. The joining step S3 and the pressing step S4 may be performed in any order.

In the embodiment of the present disclosure, the pressing step S4 is performed after the insertion step S2. More specifically, the electrode assembly unit 10a is inserted into the body 23, and then the protrusions 24b are formed on the first end wall 24 of the body 23. Thus, the electrode assembly unit 10a can be smoothly inserted into the body 23 in the insertion step S2.

Although the embodiment of the present disclosure has been described above, the embodiment disclosed herein should be considered to be illustrative in all respects and not restrictive. The technical scope of the present disclosure is defined by the claims, and is intended to include all modifications within the meaning and scope equivalent to the claims.

What is claimed is:

1. A power storage cell comprising an electrode assembly and a housing case that houses the electrode assembly, wherein
the housing case includes a first side wall, a second side wall arranged away from the first side wall in an arrangement direction, and a body connecting the first side wall and the second side wall,
the body includes a first end wall and a second end wall arranged away from the first end wall across the electrode assembly, and
the first end wall includes an exhaust valve and a protrusion that protrudes toward the electrode assembly.

2. The power storage cell according to claim 1, wherein the protrusion is provided by a recessed shape of the first end wall.

3. The power storage cell according to claim 1, further comprising an external terminal, wherein
the external terminal is provided on at least one of the first side wall or the second side wall.

4. The power storage cell according to claim 1, further comprising an external terminal, wherein
the external terminal is provided on the first end wall.

5. A method for manufacturing a power storage cell including an electrode assembly, a housing case that houses the electrode assembly, and external terminals,
the housing case including a first side wall, a second side wall arranged away from the first side wall in an arrangement direction, and a body connecting the first side wall and the second side wall,
the body including a first end wall and a second end wall arranged away from the first end wall across the electrode assembly,
the first end wall including an exhaust valve and a protrusion that protrudes toward the electrode assembly,
the external terminals including a first terminal provided on the first side wall and a second terminal provided on the second side wall,
the electrode assembly, the external terminals, the first side wall, and the second side wall constituting an electrode assembly unit,
the method comprising:
preparing the electrode assembly unit;
inserting the electrode assembly unit into the body;
joining the first side wall and the second side wall of the electrode assembly unit to the body; and
pressing the first end wall to form the protrusion.
